(19) United States
(12) Patent Application Publication
(10) Pub. No.: US 2012/0017874 A1
(43) Pub. Date: Jan. 26, 2012

(54) Fluid dispenser as well as method for the provision of a work fluid by means of a fluid dispenser

(75) Inventors: Turhan Yildirim, Winterthur (CH); Leif Knipstrom, Winterthur (CH); Andreas Carelli, Zuerich (CH)

(73) Assignee: WAERTSILAE SCHWEIZ AG, Winterthur (CH)

(21) Appl. No.: 13/096,917

(22) Filed: Apr. 28, 2011

(30) Foreign Application Priority Data
Jul. 23, 2010 (EP) 10 170 602.6

(51) Int. Cl. F02M 63/00

(52) U.S. Cl. 123/447

(57) ABSTRACT

The invention relates to a fluid dispenser for the provision of a work fluid (2) wherein the fluid dispenser includes a feed cylinder (3) having a feed piston (4, 41) arranged therein which divides the feed cylinder (3) into a control space (5) and a feed space (6). A control fluid (8) can be supplied to the control space (5) via a control inlet (7) at a predeterminable control pressure (PS) such that the work fluid (2) provided to the feed space (6) via an inlet opening (9) is available at an outlet opening (10) at a predeterminable work pressure (PA). In accordance with the invention a pressure release means (11) is provided so that the work pressure (PA) of the work fluid (2) can be modulated in dependence on time at the outlet opening (10) in accordance with a predeterminable scheme (12). The invention further relates to a combustion engine having a fluid dispenser (1), as well as to a method for the provision of a work fluid (2) by means of a fluid dispenser (1).

The invention relates to a fluid dispenser, as well as to a method for the provision of a work fluid by means of a fluid dispenser in accordance with the independent claim of the respective category.

Fuel injection systems with common rail for the accumulation of highly pressurized fuel and an injector for the injection of the highly pressurized fuel are known, for example from DE-A-103 48 404 or EP-A-2 133 540.

Object of the present invention is the provision of an apparatus and a method for the periodic discharge of a work fluid in discharge intervals during which the pressure of the work fluid can be set in a time-dependent manner, for example for the injection of a fuel into a combustion space of a combustion engine, wherein an improved metering of the injection volume with respect to the prior art should be enabled and thus a significantly improved heat release in dependence on the injection time should be established.

The subject matter of the invention satisfying the object are characterized by the features of the independent claims 1, 10 and 12. The dependent claims relate to particularly advantageous embodiments of the invention.

The invention thus relates to a fluid dispenser for the provision of a work fluid, wherein the fluid dispenser includes a feed cylinder with a feed piston arranged therein which divides the feed cylinder into a control space and a feed space. A control fluid can be supplied to the control space via a control inlet at a predeterminable control pressure such that the work fluid provided to the feed space via an inlet opening is available at an outlet opening at a predeterminable pressure. In accordance with the invention a pressure release means is provided, so that the work pressure of the work fluid can be modulated at the outlet opening in dependence on time in accordance with the predeterminable scheme.

In this respect the pressure release means is either directly or indirectly connected to the control space of the fluid cylinder, for example via a line, wherein the pressure release means in a different embodiment can also alternatively or simultaneously be connected to the feed space. This means the time dependent modulation of the work pressure of the work fluid can be carried out both by a release of the control pressure in the control space or simultaneously or alternatively by the release of the work pressure in the feed space.

In the simplest case the pressure release means, for example is a simple pressure release opening at the control space and/or at the feed space, wherein the pressure release means preferably is a passively or actively controllable restrictor and/or a valve, in particular a controllable valve.

In this respect the feed piston of the feed cylinder is particularly preferably a stepped piston, in particular in the shape of a pressure amplifying piston as is principally known from the prior art.

As was previously mentioned, in practice the pressure release means is a controllable pressure release means, wherein particularly advantageously a control unit is provided by means of which the pressure release means can be controlled and/or regulated.

In an embodiment particularly relevant for practice the fluid dispenser is a fluid dispenser for a fuel injection nozzle of a combustion engine or a fluid dispenser for a lubrication oil device for the lubrication of a cylinder wall of a cylinder of a combustion engine.

The invention further relates to a combustion engine having a fluid dispenser of the invention, wherein the combustion engine preferably is a two stroke large diesel engine for a ship.

Thus the apparatus in accordance with the invention in practice serves for the provision of a preferably periodic discharge of a work fluid, wherein during a discharge interval the work pressure of the work fluid can be set in a time-dependent manner. In this respect the fluid dispenser in accordance with the invention in practice is advantageously connectable to a pressure increasing pump, a battery or a supply tank for the provision of a work fluid at a flow pressure, wherein the flow pressure is preferably between 1 and 20 bar. In particular, a flow pressure of 1 to 10 bar is preferred. In this respect the pressure increasing pump advantageously extracts the work fluid from a storage container. The pressure increasing pump is connected to a pressure amplifying piston via a first connection means.

The feed cylinder, as is generally known, is an apparatus which typically has two cylindrical chambers in which a respective movable piston is formed, namely a control piston section and a feed piston section. The two cylindrical chambers have a coaxial longitudinal axis for this purpose. The two pistons are mechanically coupled or loose (when pressurized from both sides as coupled) that on displacement of a piston results in a synchronous longitudinal movement of both pistons. In an appropriate manner the two cylindrical chambers and thus also their pistons have different cross-sectional areas, so that a control space and a feed space is formed. The two pistons can be moved to and fro in the respective fluid chambers, wherein the pistons have suitable sealing means at their mantle surfaces which seal the fluid chambers to the outside. The space possibly provided between the control piston section and a feed piston section can be filled with gas or filled with a liquid or the control piston section and the feed piston section together form the stepped piston as a compact body, in particular form the pressure amplifying piston. In the operational state the feed space is filled with the work fluid and the control space is filled with the control fluid. Thus a corresponding synchronized movement of the control piston section and of the feed piston section along the common fluid chamber longitudinal axis can be effected through the controlled change in pressure of the control fluid.

The pressure increasing pump is thus preferably connected to the feed space of the fluid cylinder via a first connection means. The first connection means include a valve (control valve or check valve) as, one the one hand, the feed space is charged with a work fluid by means of the first connection means, on the other hand, the work fluid is discharged from the fluid space via the outlet opening of the fluid space in a pressure modulated manner, wherein the discharged work fluid can have very high pressure peaks. The feed space of the feed cylinder is thus filled with a work fluid at a feed pressure and the work fluid is then discharged from the feed space at a pressure modulated in time. For this reason the presence of a valve, preferably a check valve or a control valve is compulsory required in many cases, so that during the discharge of the work fluid from the feed space this cannot be discharged back into the (filling) line. In the case of a valve this can be used for the control of the filling of the feed space. In dependence on the grade of filling this would also define an injection volume.

The term “connection means” in the present text includes either a pipe-like connection means or a hose-like connection means for the conveyance of fluids such as gases or liquids, wherein the gases or the liquids can be subjected to high pressures.

The feed space has an outlet opening for the work fluid which is subjected to a time modulated work pressure. The control space of the feed cylinder is preferably, on the one hand, connected to a high pressure pump for a control fluid via a first control valve, as well as possibly being connected to an accumulator acting as a storage medium for the control fluid subjected to a very high pressure by means of second connection means. The control space of the feed cylinder can further be connected to a second restrictor or a regulatable restrictor and/or a further control valve for the pressure release of the control fluid present in the control space by means of third connection means.

Furthermore, the apparatus has a control unit for the metering of the injection volume and for the control of the pressure amplifying piston, as well as the first and the second control valves, such that the time-dependent predefined course of the work pressure of the work fluid at the outlet opening of the feed space of the feed cylinder can be set during the discharge intervals.

The first and second control valves are preferably 3/2 way valves, wherein at least a control valve can also be configured as a 2/2 way valve. For a 2/2 way valve only a normal through-flow takes place, this means a turn-on process or a turn-off process takes place. For a 3/2 way valve additionally a further connection is present, for example for a line venting.

The first and/or the second control valve can also include a plunger coil as a movable element.

Preferably the apparatus has at least one restrictor/regulatable restrictor for the regulation of the through-flow amount of the control fluid between the first control valve and the pressure amplifying piston. This e.g. allows a softer increase of the control pressure of the control fluid in the control space.

In a further preferred embodiment the apparatus has at least one restrictor for the regulation of the discharge flow of the control fluid from the control space of the feed cylinder between the second control valve and the pressure amplifying piston. This e.g. allows a softer, i.e. less abrupt pressure decrease in the control space.

In this respect the restrictors are preferably also controlled by the control unit which is also required for the control of the control valves.

The apparatus in accordance with the invention is in particular suited for the injection of a fuel into the combustion space if a reciprocating piston combustion engine, in particular into the combustion space of a large diesel engine.

The invention further relates to a method for the provision of a work fluid by means of a fluid dispenser, wherein the fluid dispenser includes a feed cylinder with a feed piston arranged therein so that the feed cylinder is divided into a control space and in a feed space. A control fluid is supplied to a control space via a control inlet at a predeterminable control pressure, such that the work fluid provided in the feed space via an inlet opening is made available at an outlet opening at a predeterminable work pressure. In accordance with the invention a pressure release means is provided so that the work pressure of the work fluid at the outlet opening is modulated in dependence on time in accordance with the predetermined scheme.

Particularly preferably a controllable pressure release means is provided as a pressure release means, wherein in particular for the metering of a work fluid the speed of the feed piston is controlled and/or regulated by the controllable pressure release means.

In practice the work fluid can be made available by the fluid dispenser periodically in consecutive work phases and advantageously for the metering of the work fluid in a predefined work phase a work parameter of a previous work phase can be used, for example a piston speed of the feed piston from a previous work phase can be used.

In the method in accordance with the invention for the periodic discharge of a predetermined amount of work fluid from a fluid dispenser a work fluid is pre-compressed, preferably by means of a pressure increasing pump and, in particular is guided to a reciprocating pressure amplifying piston or a path controlled pressure amplifying piston. Following this the work fluid is discharged particularly advantageously in a controlled or a regulated manner during a discharge interval from the pressure amplifying piston, wherein the pressure amplifying piston is actuated in a time-dependent manner by a control fluid having a controlled control pressure. During a discharge interval the work pressure of the work fluid can be set in a time-dependent manner in a range from 0 to 3000 bar, preferably in a range from 0-2000 bar.

Preferably two different discharge impulses of different length and separated in time are generated during each discharge interval.

Preferably each discharge interval further includes a pre-discharge impulse, a main discharge impulse and a post-discharge impulse, wherein the pre-discharge impulse and the post-discharge impulse preferably are of short duration with respect to the main discharge impulse. In particular, the duration of the pre-discharge pulse and the post-discharge pulse is preferably between 2 and 20 percent of the impulse duration of the main discharge impulse. Furthermore, the work pressure of the work fluid can be modulated during the discharge impulse also in time.

The sealing of the work fluid modulated in time can be achieved by a pressurized control fluid having a pressure of 5 to 1000 bar. In this respect in a preferred embodiment the control fluid is guided to the pressure amplifying piston by means of a first control valve for the controlled supply of control fluid into the opposite side of the piston with respect to the work fluid, this means into the control space of the feed cylinder. Furthermore, the control fluid in the control space of the feed cylinder is preferably pressure-released by a second control valve in a controlled or regulated manner. The actuation of the control valve and the possibly also present additional restrictors advantageously occurs by means of an electronic control unit.

The work fluid and the control fluid can have the same chemical composition. The work fluid and/or the control fluid can be oil, water, a fuel or a gas (liquid/gaseous). Preferably, the work fluid is a fuel, wherein the fuel is injected into the combustion space of a reciprocating piston combustion engine.

Preferably the pressure modulated work fluid is guided to an injection nozzle and to a restrictor via a line branch and subsequently to an expansion space of a setting piston and is simultaneously guided to the ring space of a needle stroke device, to effect a controlled opening and closing procedure of the needle element in a needle stroke device. The setting piston can also be impinged by work fluid and closed/controlled.

The apparatus in accordance with the invention allows a pre-spraying and a post-spraying, the setting of a variable pressure during an injection process an exact metering of the injection volume, a very small pressure reduction from the pressure amplification piston up to the injection valve, a fast spray end and a variable injection volume during the duration of injection, i.e. a variable injection rate.

The invention will be described in the following with reference to the schematic drawing. There is shown:

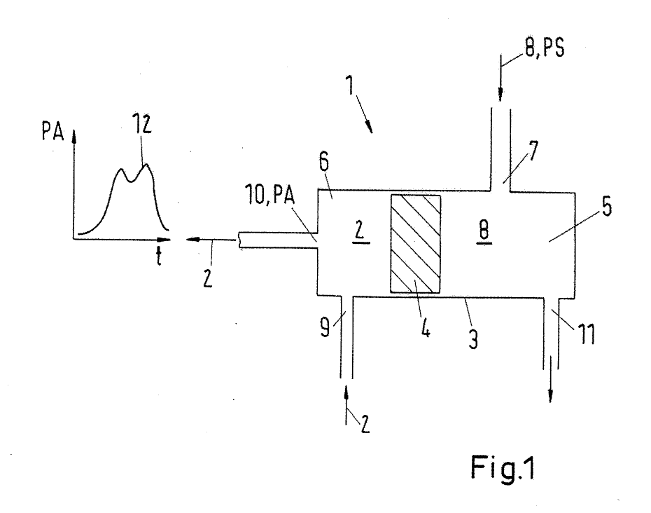

FIG. 1 a schematic illustration of a first fluid dispenser in accordance with the invention;

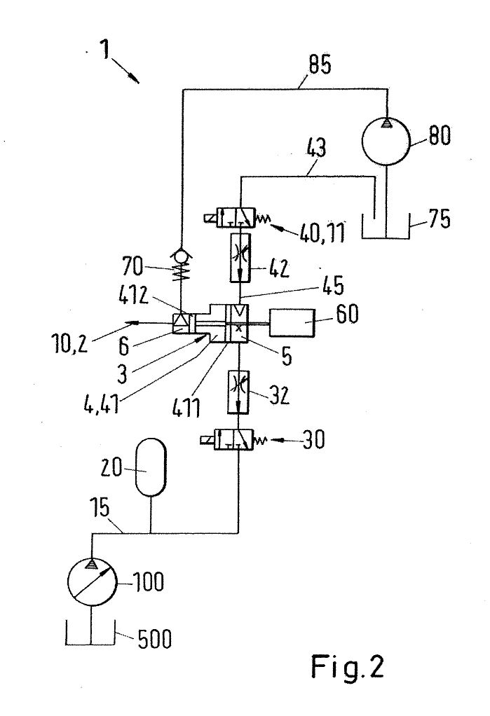

FIG. 2 a second simplified embodiment of a fluid dispenser in accordance with the invention;

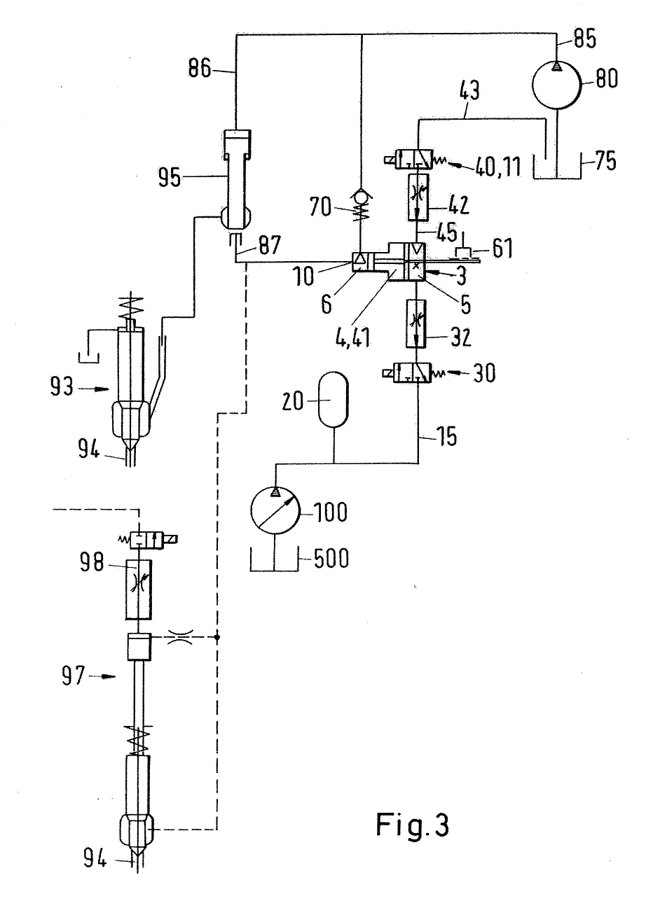

FIG. 3 a further embodiment of a fluid dispenser in accordance with the invention for a fuel injection of a diesel engine;

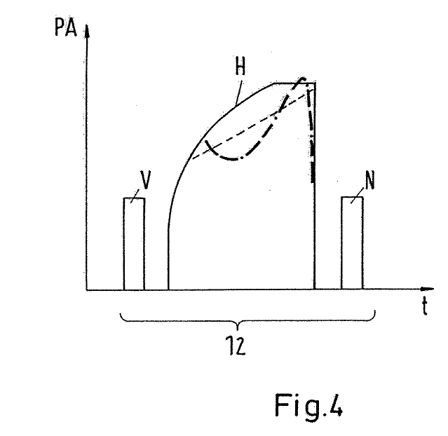

FIG. 4 schematic illustration of a timely run of the work pressure of the work fluid in a fluid dispenser in accordance with the invention.

With reference to FIG. 1, a first very simple embodiment of a fluid dispenser in accordance with the invention will be explained in the following, which will be referred to in the following totally with the reference numeral 1.

The fluid dispenser 1 for the provision of a work fluid 2 in accordance with FIG. 1 includes a feed cylinder 3 having a feed piston 4 arranged therein to divide the feed cylinder 3 into a control space 5 and a feed space 6. A control fluid 8 can be supplied to the control space 5 via a control inlet 7 at a predetermined control pressure PS such that work fluid 2 provided to the feed space 6 via an inlet opening 9 is available at an outlet opening 10 at a predetermined work pressure PA. In accordance with the invention a pressure release means 11 is provided, which in the present simple example is simply a thin release channel 11 acting as a restrictor, so that the work pressure PA of the work fluid 2 can be modulated in dependence on time at the outlet opening 10 in accordance with the predetermined scheme 12.

Naturally only a few different predetermined schemes 12 for the time dependent course of the work pressure PA can be realized with a simple release channel 5 acting as a static restrictor, as is schematically illustrated in FIG. 1. For this reason, in the following with reference to FIG. 2 and to FIG. 3 further embodiments will be described which are of greater importance for practice.

FIG. 2 shows a second simplified embodiment of a fluid dispenser 1 in accordance with the invention for the provision of the work fluid 2 at a variable work pressure PA at the outlet opening 10 of the feed cylinder 3 whose work pressure PA and the amount of fluid are variable in a time dependent manner and settable in a time dependent manner during a predetermined time interval. The feed piston 4, 41 is in this respect formed as a pressure amplifying piston 41 having a control piston section 411 and a feed piston section 412, so that the control pressure PS present at the control piston section 411 can amplify the work pressure PA in a manner known per se. The fluid dispenser 1 is connected to a pressure increasing pump 80 for the provision of a work fluid 2 at a flow pressure via a first connection means 85 with the feed space 6 of the feed cylinder 3. The first connection means 85 also includes a check valve 70. As already mentioned, the feed space 6 has an outlet 10 for the work fluid 2 at a time modulated work pressure PA.

The feed space 6 of the feed cylinder 3 is cyclically filled with a work fluid 2 having a flow pressure. Following this the work fluid 2 is respectively discharged at a high pressure modulated in time from the feed space 6 via the outlet opening 10.

The feed space 6 has two cylindrical chambers, in which the control piston section 411 and the feed piston section 412 of the feed piston 4, 41 are respectively arranged. The two cylindrical chambers have a coaxial longitudinal axis, wherein the control piston section 411 and the feed piston section 412 are mechanically coupled such that on displacement of the control piston section 411 along the longitudinal axis a synchronized longitudinal movement of the feed piston section 412 results. The two cylindrical chambers as well as the control piston section 411 and the feed piston section 412 arranged movable to and fro therein have two different cross-sectional surfaces, so that the smaller feed space 6 and the larger control space 5 can be formed. The control piston section 411 and the feed piston section 412 preferably have sealing means at their mantle surfaces, for example seal rings or labyrinth seals which are not illustrated in FIG. 2 for reasons of clarity.

The control space 5 of the feed cylinder 3 is, on the one hand, connected to a high pressure pump 10 for the control fluid 8 via a first control valve 30, and is also connected to an accumulator 20 for the control fluid 8 at a high pressure by means of a second connection means 15. The connection means 15, 85 are preferably respectively composed of pipes or reinforced pressure stable hoses. In the following the control space 5 of the feed cylinder 3 is connected to a pressure release means 11 formed as the second control valve for the pressure reduction of the control fluid 8 present in the control space 5 by means of a third connection means 45. The fluid dispenser 1 is moreover signal connected to a control unit 60 for the control of the feed piston 4, 41, as well as the first and second control valves 30, 40, 11. In this respect the control valve 40 is simultaneously the pressure release means 11 in FIG. 2 and FIG. 3. The time dependent predefined course of the work pressure PA of the work fluid 2 at the outlet opening 10 of the feed space 6 of the feed cylinder 3 directly depends on the pressure course in the control space 5 of the feed cylinder 3, wherein the pressure amplifying piston 41 is controlled by the control unit 60.

The control of the pressure amplifying piston 41 in this respect preferably occurs by means of an inlet restriction and an outlet restriction of the control space 5 by means of the control valve 30, 40, 11. Due to the regulatable restrictors 32, 42, amongst other things, the speed of the feed piston 4, 41 can be influenced.

The control unit 60 in this respect serves, in particular for the metering of the injection volume, for example when the fluid dispenser 1 in accordance with the invention is used in a fuel injection system of a reciprocating piston combustion engine in which one measures the stroke of the feed piston 4, 41. If the stroke of the feed piston 4, 41 is differentiated in time one obtains the piston speed of the feed piston 4, 41 in a manner known per se. The thereby determined piston speed of the feed piston 4, 41 can then be used for the regulation of the piston feed for the next injection.

The work fluid 2 and also the control fluid 8 can be any fluid or gas-like medium. Preferably the fluid dispenser 1 is used for a work fluid 2 composed of water, fuel or oil. The control fluid 8 can be the same fluid as the work fluid 2, but can however also be different to the work fluid 2. Thus the fluid dispenser 1 can include two separate fluid circuits or the chemical composition of the work fluid 2 and the control fluid 8 can be different.

The partial system of the work fluid 2 includes a supply container 75, a pressure increasing pump 80, a first connection means 85 including a check valve 70 as well as the feed space 6 of the feed cylinder 3 having the output 10 for the work fluid 2 which can be varied in time with regard to the fluid amount and the fluid pressure.

The partial system of the control fluid 8 includes a storage container 500, a high pressure pump 100, an accumulator 20, the second connection means 15 and the control space 5 of the feed cylinder 3, as well as the first control valve 30 located between the control space 5 and the high pressure pump 100 and the accumulator 20 and includes the pressure release means 11 connected to the control space 5 which is configured as a second control valve 11. The pressure release means 11 configured as the second control valve serves for the controlled pressure reduction and/or pressure release in the control space 5, this means for the drainage of control fluid 8 from the control space 5.

In the specific embodiment shown in FIG. 2 the control fluid 8 drained from the pressure release means 11, i.e. the control fluid 8 drained from the second control valve is guided back into the storage container 75 for the work fluid 2. Thus in the embodiment illustrated in FIG. 2 an identical fluid is used as a work fluid 2 and control fluid 8 with regard to its chemical composition. If the control fluid 8 and the work fluid 2 are chemically different then the drainage 43 must occur into the storage container 500 for the control fluid instead of into the storage container 75 of the work fluid.

FIG. 3 schematically shows a further embodiment of a fluid dispenser 1 in accordance with the invention for a fuel injection into a diesel engine, preferably for a two stroke large diesel engine. The apparatus in accordance with FIG. 4 includes, in addition to the components described with reference to FIG. 2, an injection valve 93 of a combustion engine connected to a safety valve 95 connected to the outlet 10 of the feed space 6 of the feed cylinder 3. In this respect the safety valve 95, on the one hand, is connected to the pressure increasing pump 80 and respectively to the check valve 70 by means of a return line 86 via the first connection means 85 and, on the other hand, is connected to the outlet 10 of the feed space 6 of the feed cylinder 3 by means of a line 87. The injection valve 93 is either connected to an outlet line of the safety valve 95 or is directly connected to the line 87. Instead of a conventional injection valve 93 also an electronically controlled injection valve 97 having a magnetic valve can be used. The fuel is then directly guided to the combustion space of the combustion engine via the supply line 94.

The high pressure pump 10 and the accumulator 20 supply a control fluid, in the present case a diesel fuel, with a pressure between 5 and 500 bar. The pressure amplifying piston 41 increases the pressure in the injection system 93, 97 up to the desired injection pressure in the ratio of the cross-section of the control piston section 411 and the feed piston section 412. The pressure in the accumulator 20 and the surface ratios of the control piston section 411 to the feed piston section 412 are correspondingly selected in accordance with the intended highest injection pressure. The actual injection pressure depends on the pressure at the control piston section 411 of the pressure amplifying piston 41, which is restricted on an inflow or outflow of the control fluid 8 by means of the control valve 30, 40, 11 and the restrictors 32, 42. Such a control of the two control valves 30, 40, 11 and restrictors 32, 42 allows a smoother rise of the injection pressure with respect to the prior art, the regulation of the injection pressure during the injection and an interruption of the injection (pre-injection or post-injection). The control of the restrictors 32, 42 can occur via a control valve or a flow control valve 30, 40, 11. The stroke of the valve can, for example, be controlled by means of a magnet or a voice coil valve. The first control valve 30 in combination with the second control 40, 11 intensifies the reaction force of the pressure amplifying piston 41 and reduces its reaction time. One of the control valves 30, 40, 11 can be configured as a 2/2 way valve. The amount of fuel to be injected is filled by the low pressure pump 80 via the check valve 70 with a flow pressure of 1 to 10 bar. The valve 95 is a safety valve which prevents the fuel flow into the combustion space of a combustion engine when the jet needle remains open. For the injection, either a conventional injection valve 93 or the electronically controlled injection valve 97 which is provided with a magnetic valve is used with the control unit 98. The latter has the advantage that the injection can be completed and completed very quickly independent of the piston movement which reduces the formation of smoke of the HC emission and the NOx emission of the engine.

FIG. 4 shows a schematic illustration of a run of the work pressure PA during a discharge interval of the work fluid 2 at the outlet opening 10 of the feed space 6 of the feed cylinder 3. The time t is shown on the abscissa and the work pressure PA at the outlet opening 10 of the feed cylinder 3 is shown on the ordinate. FIG. 4 shows a predeterminable scheme 12 of a discharge interval having three discharge pulses, namely a pre-discharge impulse V, a main discharge impulse H and a post-discharge impulse N. The pre-discharge impulse V and the post-discharge impulse N only have a short impulse duration. Furthermore, the work pressure PA increases very steeply, remains constant for a short time and then descends steeply again. The main discharge impulse shows a modulated run of the work pressure PA for the impulse duration. FIG. 4 shows three exemplary pressure runs during the main discharge impulse of predetermined impulse length. The solid line shows a steep but constant pressure increase up to a maximum value, wherein the latter remains essentially constant for a certain time period, before the pressure then falls back to zero. The dotted run of the work pressure PA shows a constant increase of the work pressure PA up to a point in time at which the work pressure PA steeply decreases, this means there is no constant value of the work pressure PA for a certain time frame. The hash-dotted line shows a modulated run of the work pressure PA in which the work pressure first continuously increases then continuously decreases up to a mean value and then constantly raises to a maximum before the main discharge pulse H then steeply decreases however continuously to zero.

1. A fluid dispenser for the provision of a work fluid (2) wherein the fluid dispenser includes a feed cylinder (3) having a feed piston (4, 41) arranged therein which divides the feed cylinder (3) into a control space (5) and a feed space (6) and wherein a control fluid (8) can be supplied to the control space (5) via a control inlet (7) at a predeterminable control pressure (PS) such that the work fluid (2) provided to the feed space (6) via an inlet opening (9) is available at an outlet opening (10) at a predeterminable work pressure (PA), characterized in that a pressure release means (11) is provided so that the work pressure (PA) of the work fluid (2) can be modulated in dependence on time at the outlet opening (10) in accordance with a predeterminable scheme (12).

2. A fluid dispenser in accordance with claim 1 wherein the pressure release means (11) is connected to the control space (5).

3. A fluid dispenser in accordance with claim 1 wherein the pressure release means (11) is connected to the feed space (6).

4. A fluid dispenser in accordance with claim 1 wherein the pressure release means (11) is a restrictor.

5. A fluid dispenser in accordance with claim 1 wherein the feed piston (4) is a stepped piston (4) in the shape of a pressure amplifying piston (41).

6. A fluid dispenser in accordance with claim 1 wherein the pressure release means (11) is a controllable pressure release means (11).

7. A fluid dispenser in accordance with claim 6 wherein a control unit is provided by means of which the pressure release means (11) can be controlled and/or regulated.

8. A fluid dispenser in accordance with claim 1 wherein the fluid dispenser is a fluid dispenser for a fuel injection nozzle.

9. A fluid dispenser in accordance with claim 1 wherein the fluid dispenser is a fluid dispenser for a lubrication oil device of a combustion engine.

10. A combustion engine having a fluid dispenser in accordance with claim 1.

11. A combustion engine in accordance with claim 10 wherein the combustion engine is a two stroke large diesel engine.

12. A method for the provision of a work fluid (2) by means of a fluid dispenser (1) wherein the fluid dispenser (1) includes a feed cylinder (3) having a feed piston (4) arranged therein so that the feed cylinder (3) is divided into a control space (5) and a feed space (6) and wherein a control fluid (8) is supplied to the control space (5) via a control inlet (7) at a predeterminable control pressure (PS) such that the work fluid (2) provided to the feed space (6) via an inlet opening (9) is made available at an outlet opening (10) at a predeterminable work pressure (PA), characterized in that a pressure release means (11) is provided so that the work pressure (PA) of the work fluid (2) is modulated in dependence on time at the outlet opening (10) in accordance with a predeterminable scheme (12)

13. A method in accordance with claim 12 wherein a controllable pressure release means (11) is provided as the pressure release means (11).

14. A method in accordance with claim 13 wherein for the metering of the work fluid (2) the speed of the feed piston (4) is controlled and/or regulated by the controllable pressure release means (11).

15. A method in accordance with claim 13 wherein the work fluid (2) is provided periodically in consecutive work phases by the fluid dispenser (1) and for the metering of the work fluid (2) in a predetermined work phase a work parameter of a previous work phase is used.
